(19) United States
(12) Patent Application Publication
(10) Pub. No.: US 2024/0111899 A1
(43) Pub. Date: Apr. 4, 2024

(54) DATA PROCESSING SYSTEMS AND METHODS FOR ANONYMIZING DATA SAMPLES IN CLASSIFICATION ANALYSIS

(71) Applicant: OneTrust, LLC, Atlanta, GA (US)

(72) Inventors: Kevin Jones, Atlanta, GA (US); Saravanan Pitchaimani, Atlanta, GA (US)

(21) Appl. No.: 18/264,019

(22) PCT Filed: Feb. 8, 2022
(86) PCT No.: PCT/US2022/015637

§ 371 Date: Aug. 2, 2023

Related U.S. Application Data
(60) Provisional application No. 63/146,795, filed on Feb. 8, 2021.

(51) Int. Cl. G06F 21/62; G06N 20/20

(52) U.S. Cl. CPC G06F 21/6254; G06N 20/20

(57) ABSTRACT

In general, various aspects of the present invention provide methods, apparatuses, systems, computing devices, computing entities, and/or the like for mapping the existence of target data within computing systems in a manner that does not expose the target data to potential data-related incidents. In accordance with various aspects, a method is provided that comprises: receiving a source dataset that comprises a label assigned to a data element used by a data source in handling target data that identifies a type of target data and data samples gathered for the data element; determining, based on the label, that the data samples are to be anonymized; generating supplemental anonymizing data samples associated with the label that comprise fictitious occurrences of the type of the target data; generating a review dataset comprising the supplemental anonymizing data samples intermingled with the data samples; and sending the review dataset to a review computing system.

### CROSS-REFERENCE TO RELATED APPLICATIONS

This application claims priority from U.S. Provisional Patent Application Ser. No. 63/146,795, filed Feb. 8, 2021, the entire disclosure of which is hereby incorporated herein by reference in its entirety.

### TECHNICAL FIELD

The present disclosure is generally related to systems and methods for organizing and inter-relating data in a manner that does not expose the data to potential data-related incidents.

### BACKGROUND

A significant challenge encountered by many organizations is discovering and classifying target data across multiple data assets found within multiple computing systems. Computing processes that discover and classify such target data can require a significant amount of computing resources, especially when an organization stores data across a very large number of systems which can each use their own, possibly unique process or format for storing data. Additionally, transferring data between computing systems as part of the discovery process, classification process, or other processes can expose the data to a significant risk of experiencing some type of data incident involving the data, such as a data breach leading to the unauthorized access of the data, a data loss event, etc. Therefore, a need exists in the art for improved systems and methods for discovering and classifying personal data that address these and other challenges.

### SUMMARY

In general, various aspects of the present invention provide methods, apparatuses, systems, computing devices, computing entities, and/or the like for mapping the existence of target data within computing systems in a manner that does not expose the target data to potential data-related incidents. In accordance with various aspects, a method is provided. According, the method comprises: receiving, by computing hardware from a source computing system, a source dataset, wherein the source dataset comprises a label assigned to a data element used by a data source found in the source computing system in handling target data and a plurality of data samples gathered for the data element from the data source; determining, by the computing hardware based on the label assigned to the data element, that the plurality of data samples is to be anonymized, wherein: (1) the label identifies a type of the target data associated with the data element and (2) each of the plurality of data samples comprises a real occurrence of the type of the target data handled by the data source involving the data element; generating, by the computing hardware and based on determining that the plurality of data samples is to be anonymized, a plurality of supplemental anonymizing data samples, wherein each of the plurality of supplemental anonymizing data samples is associated with the label and comprises a fictitious occurrence of the type of the target data handled by the data source involving the data element; generating, by the computing hardware, a review dataset comprising the plurality of supplemental anonymizing data samples intermingled with the plurality of data samples; and sending, by the computing hardware, the review dataset over a network to a review computing system.

According to some aspects, generating the plurality of supplemental anonymizing data samples comprises: identifying a subset of supplemental anonymizing data samples from a pool of supplemental anonymizing data samples for a plurality of types of the target data, each supplemental anonymizing data sample of the subset of supplemental anonymizing data samples is associated with the type of the target data; and selecting the plurality of supplemental anonymizing data samples from the subset of supplemental anonymizing data samples. In addition, according to some aspects, generating the plurality of supplemental anonymizing data samples comprises generating each of the plurality of supplemental anonymizing data samples via a random generator. Further, according to some aspects, the label comprises data identifying the type of the target data as at least one of a first name, a last name, a telephone number, a social security number, a credit card number, an account number, or an email address.

According to some aspects, the method further comprises processing at least one of the plurality of data samples using a machine-learning classification model to generate the label. In addition, according to some aspects, the method further comprises scanning metadata for the data source to identify the data element as being used to handle the target data. Further, according to some aspects, the method further comprises modifying each of the plurality of data samples and the plurality of supplemental anonymizing data samples to mask the plurality of data samples and the plurality of supplemental anonymizing data samples.

In addition in accordance with various aspects, a non-transitory computer-readable medium having program code that is stored thereon. In particular aspects, the program code executable by one or more processing devices performs operations that include: receiving a source dataset from a source computing system, wherein the source dataset comprises a first label assigned to a first data element used by a data source found in the source computing system in handling target data, a first plurality of data samples gathered for the first data element from the data source, a second label assigned to a second data element used by the data source in handling the target data, and a second plurality of data samples gathered for the second data element from the data source; determining, based on the first label assigned to the first data element, that the first plurality of data samples does not need to be anonymized, wherein: (1) the first label identifies a first type of the target data associated with the first data element and (2) each of the first plurality of data samples comprises a real occurrence of the first type of the target data handled by the data source involving the first data element; determining, based on the second label assigned to the second data element, that the second plurality of data samples is to be anonymized, wherein: (1) the second label identifies a second type of the target data associated with the second data element and (2) each of the second plurality of data samples comprises a real occurrence of the second type of the target data handled by the data source involving the second data element; generating, based on determining that the second plurality of data samples is to be anonymized, a plurality of supplemental anonymizing data samples, wherein each of the plurality of supplemental anonymizing data samples is associated with the second label and comprises a fictitious occurrence of the second type of the target data handled by the data source involving the second data element; and generating a review dataset comprising the first plurality of data samples, the second plurality of data samples, and the plurality of supplemental anonymizing data samples, wherein the plurality of supplemental anonymizing data samples is intermingled with the second plurality of data samples within the review dataset.

According to some aspects, the operations further comprising sending the review dataset over a network to a review computing system. In addition, according to some aspects, generating the plurality of supplemental anonymizing data samples comprises: identifying a subset of supplemental anonymizing data samples from a pool of supplemental anonymizing data samples for a plurality of types of the target data, each supplemental anonymizing data sample of the subset of supplemental anonymizing data samples is associated with the second type of the target data; and selecting the plurality of supplemental anonymizing data samples from the subset of supplemental anonymizing data samples. Further, according to some aspects, generating the plurality of supplemental anonymizing data samples comprises generating each of the plurality of supplemental anonymizing data samples via a random generator. Furthermore, according to some aspects, the first label and the second label comprise data identifying the first type of the target data and the second type of the target data as at least one of a first name, a last name, a telephone number, a social security number, a credit card number, an account number, or an email address.

In accordance with various aspects, a system is provided. In particular aspects, the system comprises first computing hardware configured to perform operations comprising: identifying a data element used by a data source in handling target data; processing real occurrences of data for the data element to generate a label identifying a type of target data being handled by the data element; and generating a source dataset comprising the label and a plurality of data samples for the data element, wherein each of the plurality of data samples comprises one of the real occurrences of data for the data element. In addition, the system comprises second computing hardware communicatively coupled to the first computing hardware, wherein the second computing hardware is configured to perform operations comprising: receiving the source dataset from the first computing hardware; determining, based on the label assigned to the data element in the source dataset, that the plurality of data samples is to be anonymized; generating, based on determining that the plurality of data samples is to be anonymized, a plurality of supplemental anonymizing data samples, wherein each of the plurality of supplemental anonymizing data samples is associated with the label and comprises a fictitious occurrence of data for the data element; and generating a review dataset comprising the plurality of supplemental anonymizing data samples intermingled with the plurality of data samples.

According to some aspects, the system further comprises third computing hardware configured to perform operations comprising: receiving the review dataset from the second computing hardware; processing the review dataset using a rules-based model to determine the data element is not handling the type of target data; and responsive to determining the data element is not handling the type of target data, generate a notification that the label is incorrect. According to other aspects, the system further comprises third computing hardware configured to perform operations comprising: providing the review dataset for viewing on a graphical user interface; receiving an indication via the graphical user interface that the label for the data element is correct; and responsive to receiving the indication, storing data indicating the data element is used by the data source for handling the type of target data.

According to some aspects, the first computing hardware is configured for processing the real occurrences of data for the data element to generate the label using a machine-learning classification model. According to some aspects, the first computing hardware is configured for identifying the data element used by the data source in handling the target data by scanning metadata for the data source to identify the data element as being used to handle the target data.

According to some aspects, the second computing hardware generates the plurality of supplemental anonymizing data samples by performing operations comprising: identifying a subset of supplemental anonymizing data samples from a pool of supplemental anonymizing data samples for a plurality of types of the target data, each supplemental anonymizing data sample of the subset of supplemental anonymizing data samples is associated with the type of target data; and selecting the plurality of supplemental anonymizing data samples from the subset of supplemental anonymizing data samples. According to some aspects, the second computing hardware generates the plurality of supplemental anonymizing data samples by performing operations comprising generating each of the plurality of supplemental anonymizing data samples via a random generator. According to some aspects, the second computing hardware is configured to perform operations comprising modifying each of the plurality of data samples and the plurality of supplemental anonymizing data samples to mask the plurality of data samples and the plurality of supplemental anonymizing data samples.

### BRIEF DESCRIPTION OF THE DRAWINGS

In the course of this description, reference will be made to the accompanying drawings, which are not necessarily drawn to scale, and wherein:

FIG. 1 depicts an example of a computing environment that can be used for mapping target data for one or more data sources to generate datasets and anonymizing data samples provided in the datasets in accordance with various aspects of the present disclosure;

FIG. 2 depicts a process flow among the various modules used for mapping target data for a data source in accordance with various aspects of the present disclosure;

FIG. 3 depicts an example of a process for generating a review dataset with anonymized data samples in accordance with various aspects of the present disclosure;

FIG. 4 depicts an example of a process for scanning a data source in accordance with various aspects of the present disclosure;

FIG. 5 depicts an example of a process for labeling data elements in accordance with various aspects of the present disclosure;

FIG. 6 depicts an example of a process for anonymizing data samples in accordance with various aspects of the present disclosure;

FIG. 7 depicts an example of a process for reviewing a review dataset in accordance with various aspects of the present disclosure;

FIG. 8 depicts an example of a system architecture that may be used in accordance with various aspects of the present disclosure; and

FIG. 9 depicts an example of a computing entity that may be used in accordance with various aspects of the present disclosure.

### DETAILED DESCRIPTION

### Overview and Technical Contributions of Various Aspects

Discovering particular target data (e.g., personal data) across a plurality of data sources (e.g., when processing a query to provide the target data) can prove to be a significant technical challenge for many entities. This is because of the volume of personal data that may be collected, processed, stored, and/or the like by any single entity can be significant. In addition, the collection, processing, storage, and/or like of the personal data for the entity can involve a significant number of computing systems, and components thereof, that are both internally managed by the entity or externally managed by a third-party for the entity. Therefore, a significant challenge for any entity that is handling (e.g., collecting, processing, storing, and/or the like) personal data in providing data responsive to one or more queries related to that data (e.g., when an individual entitled to the data responsive to the one or more queries submits such a query) is the need to detect exactly where the personal data exists within computing systems for the entity.

In addressing this challenge, many entities will go through the exercise of mapping personal data for various data sources found within computing systems handling the personal data to identify where the personal data exists within the computing systems to assist the entities in fulfilling data subject access requests. Software tools that automatically detect, generate, and/or suggest mappings of personal data or other target data within different computing systems can facilitate these exercises. However, these mapping exercises can lead to additional technical challenges. One such challenge is that many mapping processes involve transferring such personal data (e.g., or other target data) between computing systems as part of the mapping process (e.g., for classification, verification of classification, etc.). Such data transfers can pose a significant risk of a data subject's personal data being exposed in a manner that can lead to data-related incidents such as data loss incidents and data breaches.

For instance, software tools used in data mapping are more effective when their outputs regarding a mapping of target data can be validated through a review of at least some of that target data. In one example, a source computing system may transfer target data to a review computing system to enable personnel of entities to review real occurrences of personal data handled by the various computing systems in verifying the mapping of the personal data within the systems. Real occurrences of personal data include, for example, personal data stored in the source computing system (or a storage system accessible via the source computing system) that has been sampled to verify the accuracy of a mapping of the personal data within the computing systems. Providing such a feature to ensure that data mapping software is performing properly, however, can present additional risks. For instance, personnel reviewing the real occurrences of personal data handled may copy a data subject's personal data, such as credit card data, for nefarious reasons.

Various aspects of the present disclosure overcome many of the technical challenges associated with mapping the existence of personal data within computing systems in a manner that reduces the risk of data-related incidents, such as those discussed above. Specifically, various aspects of the disclosure are directed to a computer-implemented process for anonymizing data samples in classification analyses, such as those in data mapping tools. This process can involve intermingling real data samples used for review with supplemental anonymizing data samples. The supplemental anonymizing data samples can be fictitious occurrences of data within one or more computing systems that are similar in nature to the real data samples. The intermingling of real data samples and supplemental anonymizing data samples allow for verification of a data mapping tool's proper operation while obfuscating sensitive information used in the verification.

In an illustrative example, a computing system automatically labels (classifies) data elements used by a data source found within a computing system for handling target data. For example, a data source may be a database, server, or some other component found within a computing system that is used in handling target data within the system. Accordingly, the data source may handle the target data by, for example, storing the target data, processing the target data, modifying the target data, transferring the target data, and/or the like.

Continuing with this example, a scan module can be installed within a computing system so that the scan module can scan a data source found within the computing system to identify data elements associated with the data source that are used in handling target data. For example, a data element may be a data field found in a table of a database that is used for storing target data. In addition, a classification module can be installed within the computing system that labels the data elements identified as associated with handling the target data. According to particular aspects, the classification module uses a machine-learning classification model in labeling the identified data elements. For example, a label for a data element can identify the type of target data that is associated with (e.g., stored in) the data element.

According to various aspects, the respective labels assigned to each of the data elements can be used in one or more subsequent processing activities in determining whether data samples provided for each of the data elements should be anonymized. Specifically, after a particular data element is assigned a label (e.g., the data element is assigned a label such as a “First Name”), the data samples gathered for the data element may be sent to an anonymizer module. In turn, the anonymizer module anonymizes the data samples by using the identified label for the data element to generate supplemental anonymizing data samples. The anonymizer module then inserts the supplemental anonymizing data samples into a review dataset along with the original data samples. The review dataset can then be subsequently used to verify the mapping of the data element (e.g., used to verify the data element has been correctly labeled).

According to various aspects, each of the supplemental anonymizing data samples represents a fictitious occurrence of the type of target data identified by the label assigned to the data element. Each fictitious occurrence of the type of target data may, for example, include any piece of data of the type of the target data identified by the label assigned to the data element that was not included in the set of data samples gathered for the data element. In some aspects, each fictitious occurrence of the type of target data may have a format that corresponds to a format of the type of target data in the set of data samples. Therefore, the anonymizer module anonymizes the data samples for the data element by intermingling the supplemental anonymizing data samples with the data samples gathered for the data element that have real occurrences of the type of target data identified by the label, since the data samples can no longer be easily associated with a real data subject based on, for example, other proximate data samples found in the review dataset. As a result, personnel who review the review dataset (data samples thereof) may be unable to associate any particular data sample with a real data subject. Therefore, mapping target data for the data source can be conducted in a manner that minimizes the potential for data-related incidents occurring that involve real occurrences of the target data.

It is noted that reference is made to target data throughout the remainder of the application. However, target data is not necessarily limited to information that may be considered as personal and/or sensitive in nature but may also include other forms of information that may be of interest. For example, target data may include data on a particular subject of interest, such as a political organization, manufactured product, current event, and/or the like. Further, target data may not necessarily be associated with an individual but may be associated with other entities such as a business, organization, government, association, and/or the like.

### Example Computing Environment

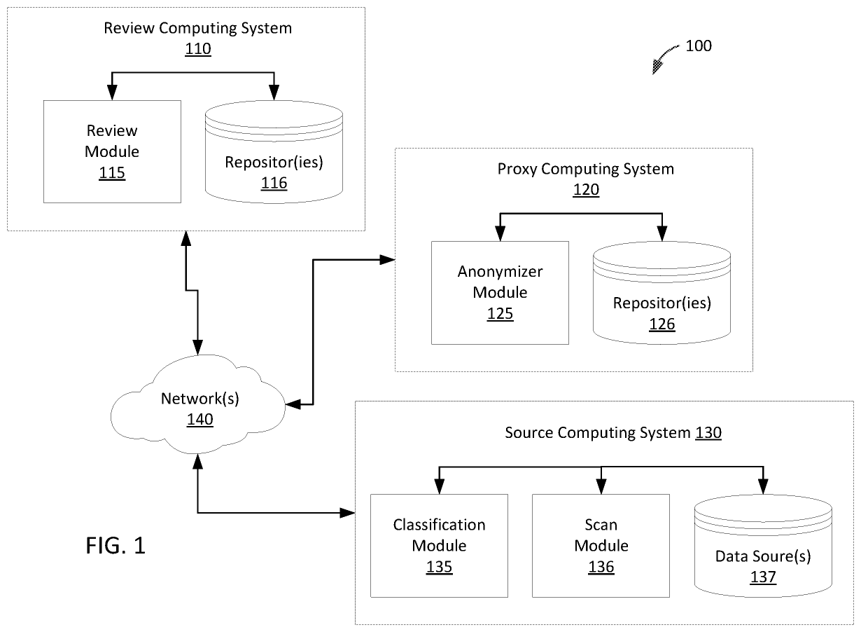

FIG. 1 depicts an example of a computing environment 100 that can be used for mapping target data handled by one or more data sources and anonymizing data samples for data elements identified through the mapping and associated with the one or more data sources according to various aspects. An entity that handles target data within a source computing system 130 may be interested in mapping the target data for one or more data sources 137 found within the source computing system 130. In addition, the entity may be interested in doing so in a secure manner that avoids exposing real occurrences of the target data that can lead to data-related incidents such as data theft.

In general, mapping of the one or more data sources 137 involves discovering and classifying target data that is handled by the one or more data sources 137. Here, the process for mapping a particular data source 137 may involve discovering data elements associated with the data source that may be used in handling the target data. For example, the data source 137 may be a database used in storing the target data. Here, the mapping process may involve discovering data fields found in tables of the database that are used in storing the target data. Specifically, the mapping process may involve scanning metadata of the database to identify those fields found in tables of the database that are used in storing the target data. In addition to identifying the data elements, the mapping process may involve collecting samples for each of the data elements of actual target data handled by the data element.

Once the data elements have been identified, the mapping process can continue with classifying the identified data elements with respect to the types of target data the elements handle. For example, the mapping process may involve processing the collected samples for each of the data elements using a machine-learning classification model in generating a label for the data element, with the label identifying the type of target data handled by the data element. For example, the target data may involve personal data and a label for a data element may identify that the data element is used in handling an individual's first name, last name, email address, social security number, and/or the like.

The mapping process may then continue with verifying that the data elements have been labeled correctly with respect to the types of target data they handle. Therefore, personnel (an individual) may review the label and corresponding samples corrected for each of the data elements and verify (confirm) the data elements have been labeled correctly. The personnel can then make any corrections to the labeling of the data elements as needed. Once verified, the mapping results (e.g., the labeled data elements for the data source) can be used for a variety of tasks.

For example, the entity may be collecting personal data from individuals (e.g., data subjects) and storing the personal data in one or more data sources 137 found within the source computing system 130. The entity may be subject to fulfilling data subject access requests (DSARs) and other queries related to the collected personal data. Such requests may involve, for example, the entity providing the personal data for a data subject upon request, providing information on the personal data for a data subject such as reasons for collecting the personal data upon request, deleting the personal data for a data subject upon request, and/or the like. Therefore, the entity may be interested in knowing where the personal data exists within the source computing system 130 (e.g., where the personal data exists within the one or more data sources 137) so that the entity can fulfill DSARs received for the personal data. In addition, the entity may be interested in knowing certain information about the personal data. For example, the entity may be interested in knowing what types of personal data are being handled for data subjects such as, data subjects' first name, last name, home address, telephone numbers, social security numbers, email addresses, credit card numbers, and/or the like. Accordingly, such information may be helpful to the entity in fulfilling certain DSARs.

The term “handling” is used throughout the remainder of the specification in discussing various aspects of the disclosure with mapping and anonymizing target data for computing systems handling such data. “Handling” may involve performing any of various types of activities in regard to the target data such as processing, collecting, accessing, storing, retrieving, revising, and/or deleting, the target data.

According to various aspects, the source computing system 130 can execute a scan module 136 to facilitate mapping the one or more data sources 137 for the source computing system 130. The scan module 136 may include software components that are installed within the source computing system 130. For example, the scan module 136 may be installed on one or more hardware components within the source computing system 130. As discussed further herein, the scan module 136 scans a data source 137 found within the source computing system 130 to identify data elements associated with the data source 137 that are used in handling the target data. For example, the scan module 136 can identify data fields of a data repository that are used in storing the target data. Accordingly, the scan module 136 may accomplish this task by scanning metadata for the data source 137 to identify the data elements.

In addition to identifying the data elements of the data source 137 used for handling target data, the scan module 136 collects one or more data samples for each of the identified data elements. Here, each of the data samples represents a real occurrence of the type of target data handled by the corresponding data element found in the source computing system 130 (e.g., in the data source 137). For example, a data element may be used in storing a data subject's last name. Therefore, a data sample for this data element may be “Smith,” “Anderson,” “Williams,” and/or the like. As discussed further herein, the data samples can be used in verifying the type of target data that is associated with the data element. By installing the scan module 136 locally within the source computing system 130, the scan module 136 can scan a data source 137 and collect data samples for various data elements in a secure manner without unintentionally exposing the real occurrences of the target data found in the data samples. However, other aspects of the disclosure may involve the scan module 136 residing remotely from the source computing system 130 and scanning the various data sources 137 found in the source computing system 130 over one or more networks 140.

Similar to the scan module 136, a classification module 135 that includes software components may also be installed on one or more hardware components within the source computing system 130. The classification module 135 labels each of the identified data elements used for handling target data based on the data samples collected for the data elements. A label for a data element identifies a type of target data associated with the data element. According to various aspects, the classification module 135 makes use of a machine-learning classification model in generating the label for each of the data elements. As discussed further herein, the machine-learning classification model may be configured as an ensemble that includes classifiers for a variety of types of target data that may be associated with the different data elements. For example, the machine-learning classification model may include a classifier for first name, a classifier for last name, a classifier for email address, and so forth. Therefore, the classification module 135 may identify (assign) an appropriate label for a data element based on a classifier generating a prediction that satisfies a threshold (e.g., a prediction value that satisfies a threshold).

Again, installing the classification module 135 locally within the source computing system 130 can allow the classification module 135 to generate labels for the various data elements in a secure manner without unintentionally exposing the real occurrences of the target data found in the data samples. However, in other aspects, the classification module 135 may reside remotely from the source computing system 130 and label data elements associated with various data sources 137 found in the source computing system 130 over one or more networks 140.

A review computing system 110 may be provided that includes software components and/or hardware components for reviewing a mapping of target data generated for one or more data sources 137 found within a source computing system 130 of an entity. According to various aspects, the review computing system 110 may provide a data mapping review service that is accessible over one or more networks 140 (e.g., the Internet) by the entity (e.g., a computing system 130 associated with the entity). Here, personnel of the entity may access the service over the one or more networks 140 through one or more graphical user interfaces (e.g., webpages) and use the service in initiating a scan of one or more data sources 137 found in a source computing system 130 of the entity to generate a mapping of target data. In addition, the personnel can conduct a review of the mapping of target data generated for the one or more data sources 137 via the data mapping review service.

According to particular aspects, the entity may subscribe to the data mapping review service and in doing so, may have the scan module 136 and/or classification module 135 installed within the source computing system 130 of the entity to perform the operations previously discussed. The source computing system 130 can then provide the results (e.g., a review dataset) generated from scanning one or more data sources 137 found in the source computing system 130 to the review computing system 110 (e.g., by transmitting the results over one or more networks 140) to facilitate review of the results from mapping the target data for the data source(s) 137. Upon receiving the results, the review computing system 110 may store the results in one or more repositories 116.

According to some aspects, a review module 115 may be provided by the review computing system 110 that can be used in automating certain aspects of the review process for reviewing the results. For example, as discussed further herein, the review module 115 may process the data samples for each of the identified data elements using a rules-based model in identifying those data elements that may have been mislabeled. Here, the rules-based model may utilize a set of rules configured to analyze the assigned label to a data element in light of the data samples provided for the data element in the results to determine whether the data element has been mislabeled. The review module can then display the results of the analysis to personnel of the entity. Accordingly, the analysis can help the personnel in filtering down the results that need to be reviewed.

Thus, the review process can involve the personnel for the entity reviewing various data elements identified for the data source(s) 137 associated with handling the target data, and associated data samples, to determine whether the classification module 135 has accurately labeled the data elements. Therefore, the review process can often involve exposing the data samples for the various data elements to the personnel. As noted, the data samples collected for a particular data element often represent real occurrences of the target data associated with the data element. For example, an identified data element may be used in storing credit card numbers for real data subjects (e.g., real individuals). Therefore, the data samples collected for this particular data element may provide real credit card numbers of data subjects (e.g., individuals). Exposing the real credit card numbers to personnel of the entity can lead to data-related incidents such as the personnel acquiring (e.g., copying) the credit card numbers for nefarious purposes.

To help combat this challenge, a proxy computing system 120 is provided according to various aspects that intercepts the results (source dataset) of the mapping of the target data for the one or more data sources 137 and anonymizes the data samples for various data elements before providing the results for review. Here, the proxy computing system 120 includes software components and/or hardware components for anonymizing the data samples found in the results. Specifically, the proxy computing system 120 includes an anonymizer module 125 that is used in anonymizing the data samples for various data elements found in the results. The anonymizer module 125 goes about this task by identifying those data elements found in the results that need to have their data samples anonymized. The anonymizer module 125 then generates supplemental anonymizing data samples for each of the data elements identified as needing to have its data samples anonymized.

According to particular aspects, the anonymizer module 125 performs this operation by retrieving (querying) the supplemental anonymizing data samples from a pool of supplemental anonymizing data samples having data samples for the various types of target data that may be handled by the data source(s) 137 of the source computing system 130. The supplemental anonymizing data samples may represent fictitious occurrences of the various types of target data. Therefore, the anonymizer module 125 retrieves the supplemental anonymizing data samples for a particular data element based on the label that has been assigned to the data element and intermingles the supplemental anonymizing data samples with the actual data samples found in the results for the data element. The proxy computing system 120 may store the pool of supplemental anonymizing data samples in one or more data repositories 126 found within the proxy computing system 120.

According to other aspects, the anonymizer module 125 may generate the supplemental anonymizing data samples using a random generator. Here, the random generator may be configured to generate supplemental anonymizing data samples for a data element that have a format similar to the format of the actual data samples found in the results for the data element. For example, the random generator may generate supplemental anonymizing data samples having fictitious occurrences of the type of target data identified for the data element with similar characteristics and/or in a similar format structure as the real occurrences of the type of target data found in the data samples provided for the data element in the results. As a specific example, the type of target data identified for a particular data element may be a telephone number. Therefore, the anonymizer module 125 may generate one or more supplemental anonymizing data samples having numbers in a format such as “XXX-XXX-XXXX” that are then intermingled with the data samples provided for the particular data element in the results.

As previously noted, intermingling the supplemental anonymizing data samples with the data samples gathered for a data element having real occurrences of the type of target data identified by the label anonymizes the data samples for the data element since the data samples can no longer be easily associated with a real data subject based on, for example, other proximate data samples in the review dataset. As a result, personnel who review the review dataset (data samples thereof) may be unable to associate any particular data sample with a real data subject. Therefore, mapping target data for the data source can be conducted in a manner that minimizes the potential for data-related incidents involving real occurrences of the target data. In addition, configuring the proxy computing system 120 as a remote system, separate from the review computing system 110, can provide additional security in ensuring that the results are made available for review in a manner that helps minimize the possibility of experiencing a data-related incident involving the results. This is because the proxy computing system 120 can intercept the results and anonymize the data samples for one or more data elements provided in the results prior to the results being made available on the review computing system 110. Therefore, the proxy computing system 120 can anonymize the data samples before the results are transferred to the review computing system 110. Such a configuration can help to ensure that the personnel are unable to gain access to the results before the data samples have been appropriately anonymized.

However, with that said, the computing environment 100 may be configured differently according to particular aspects in which the components (e.g., the anonymizer module 125 and/or repositories 126) of the proxy computing system 120 may be integrated into the source computing system 130 and/or the review computing system 110. For example, according to some aspects, the anonymizer module 125 and/or repositories 126 used for storing the pool of supplemental anonymizing data samples may be installed on the source computing system 130, similar to the scan module 136 and/or the classification module 135. Such a configuration can still ensure the data samples for data elements that need to be anonymized can do so prior to the results for mapping the target data for the one or more data sources 137 are made available on the review computing system 110.

However, according to other aspects, the anonymizer module 125 and/or repositories 126 used for storing the pool of supplemental anonymizing data samples may be installed on the review computing system 110. Here, for example, one or more access controls can be put into place to restrict access to the results to personnel of the entity until the data samples for one or more data elements that need to be anonymized have been anonymized.

### Flow of Dataset Among the Various Modules

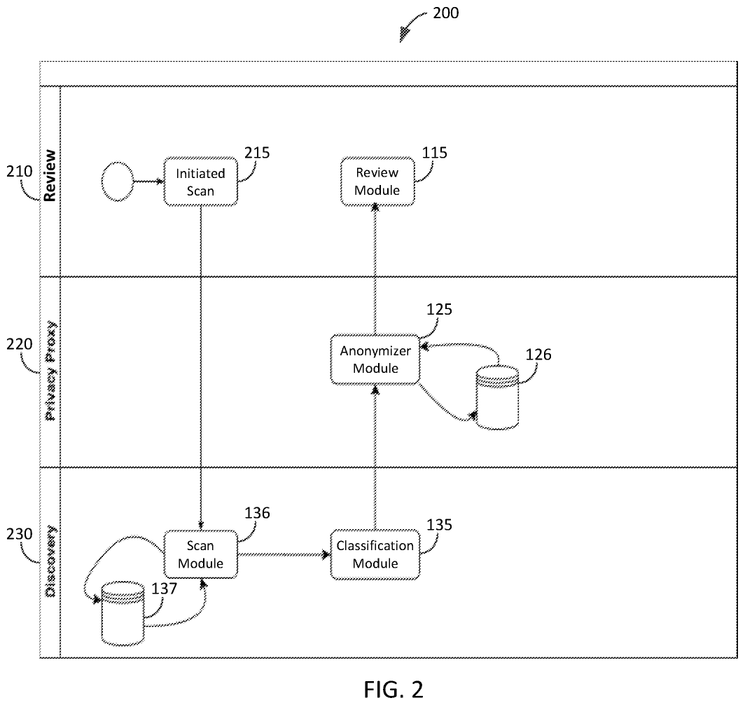

FIG. 2 depicts a process flow 200 among the various modules described with respect to the computing environment is shown in FIG. 1. As previously noted, because the source computing system 130 may handle target data that is considered sensitive in nature, such as personal data of data subjects and/or other sensitive data, data samples provided for various data elements identified as related to the target data may be anonymized due to the data samples having real occurrences of types of target data associated with the data elements. Accordingly, anonymizing the data samples can allow for an evaluation of the accuracy of labels (e.g., types of target data) assigned to the data elements to be conducted in a manner without revealing the sensitive content of such data elements.

A user, or alternatively a computing component, may initiate a scan 215 of a data source 137 found within a source computing system 130 as part of a review process 210. For example, the user may be personnel of an entity associated with the source computing system 130 who has accessed a data mapping review service provided through a review computing system 110. Here, the service may provide the user with one or more graphical user interfaces through which the user can identify the data source 137 that the user wishes to have scan for target data. Further, the user may provide additional information that can be used to conduct the scan of the data source 137 such as, for example, a category identifying the target data, a location of metadata stored on the data source 137, and/or credentials needed to access the data source 137 and/or metadata.

According to various aspects, a scan module 136 and classification module 135 may have been installed within the source computing system 130 to assist the user in conducting the scan of the data source 137. Therefore, in response to initiating the scan 215, the source computing system 130 may initiate a discovery process 230 that involves the scan module 136 identifying data elements of the data source associated with handling the target data, as well as collecting data samples for the identified data elements, to generate a source dataset. In addition, the discovery process 230 may involve the classification module 135 generating labels for the identified data elements. As previously noted, the classification module 135 may use a machine-learning classification model according to various aspects in processing one or more of the data samples for a data element in generating a label for the data element that identifies a type of target data associated with the data element.

The classification module 135 (or some other module) may then transmit the labeled source dataset to an anonymizer module 125 that is executed as part of a proxy process 220. As previously noted, the anonymizer module 125 may reside on a proxy computing system 120 that is independent of the review computing system 110. The anonymizer module 125 analyzes the respective label associated with each data element identified in the labeled source dataset and determines whether the data samples for the respective data element should be anonymized. If so, then the anonymizer module 125 generates one or more supplemental anonymizing data samples for the data element having the same type of target data to generate a review dataset that includes both the data samples found in the labeled source dataset for the data element and the supplemental anonymizing data sample(s) generated for the data element.

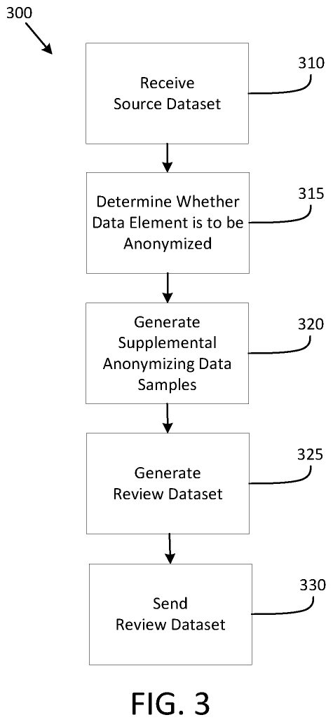

For example, briefly turning to FIG. 3, a process for generating a review dataset having anonymized data samples for certain data elements is provided according to various aspects. Here, at Operation 310, the anonymizer module 125 may receive the source dataset from the classification module 135 residing on the source computing system 130. As noted, the source dataset may include labels assigned to data elements used by a data source found in the source computing system 130 in handling target data and data samples gathered for each of the data elements. Here, each of the data samples for a data element may comprise a real occurrence of the type of the target data handled by the data source involving the data element and the label may identify the type of target data. Therefore, the anonymizer module 125 may determine, based on the labels assigned to the data elements, that the data samples provided in the source dataset for one or more of the data elements need to be anonymized in Operation 315.

Accordingly, in Operation 320, the anonymizer module 125 generates supplemental anonymizing data samples for the one or more data elements that are determined to have their data samples anonymized. Each of the plurality of supplemental anonymizing data samples is associated with the label and comprises a fictitious occurrence of the type of the target data handled by the data source involving the data element. At Operation 325, the anonymizer module 125 generates a review dataset comprising the supplemental anonymizing data samples intermingled with the data samples for each of the one or more data elements. As previously noted, intermingling the supplemental anonymizing data samples with the data samples gathered for the data element having real occurrences of the type of target data identified by the label anonymizes the data samples for the data element since the data samples can no longer be easily associated with a real data subject. At this point, the anonymizer module 125 (or some other module) sends (e.g., transmits) the review dataset to the review computing system 110 in Operation 330.

Returning to FIG. 2, the review process 210 may involve a review module 115 initially analyzing the review dataset to determine whether any of the data elements identified for the data source 137 that are involved in handing the target data have been mislabeled. The results of the analysis may then be displayed to the user who initiated the scan (or some other user).

Accordingly, the review process 210 can continue with the user who initiated the scan (or some other user) reviewing the review dataset in determining whether the data elements identified for the data source as involved with handling the target data have been properly (correctly) labeled with the type of target data associated with the element elements. Here, the user may view the data samples provided in the review dataset for a data element in determining whether the data element has been properly labeled. Therefore, as a result of the data samples being anonymized, the user may be unable to associate any particular data sample with a real data subject. Once the user has reviewed the review dataset, corrected any mislabeled data elements, and/or verified any corrected data elements, the results of the review may be saved for used by the entity in conducting operations involving the data source and target data. For example, the entity may use the verified mapping of the target data for the data source in fulfilling DSARs as previously discussed. Further detail is provided below regarding the configuration and functionality of the scan module 136, classification module 135, anonymizer module 125, and review module 115 according to various aspects of the disclosure.

### Scan Module

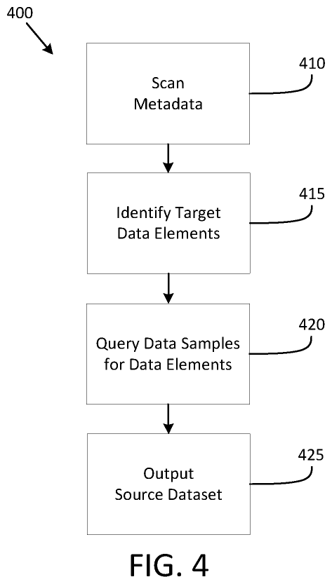

Turning now to FIG. 4, additional details are provided regarding a scan module 136 used for scanning a data source 137 of a source computing system 130 to identify data elements associated with the data source 137 that are involved in handling target data in accordance with various aspects of the disclosure. As previously noted, the scan module 136 according to various aspects can be installed within the source computing system 130. Therefore, the flow diagram shown in FIG. 4 may correspond to operations carried out, for example, by computing hardware found in the source computing system 130 as described herein, as the computing hardware executes the scan module 136.

As previously noted, a user (or some computer component) may initiate a scan of the data source 137 from a review computing system 110. For example, the user may initiate the scan through one or more graphical user interfaces provided by the review computing system 110 via a data mapping review service. In turn, the review computing system 110 may send a request over one or more networks 140 to the scan module 136 to invoke the scan module 136 to conduct the scan of the data source 137. Here, the request may identify the data source 137 that is to be scanned, as well as a category identifying the target data. For example, the request may identify a database found within the source computing system 130 and the category as personal data of data subjects stored in the database. In addition, the request may identify a location of metadata for the data source 137 that can be accessed to identify data elements associated with the data source 137 that are involved in handling the target data. Further, the request may provide credentials needed to access the data source 137, although the credentials may be stored locally within the source computing system 130 for security purposes. In these instances, the scan module 136 may access the credentials that are stored locally.

Therefore, according to various aspects, the process 400 involves the scan module 136 scanning metadata for the data source 137 in Operation 410 to identify data elements associated with the data source 137 that are involved in handling the target data in Operation 415. For instance, returning to the example where the data source 137 is a database, the scan module 136 may scan a schema of the database in identifying data fields found in various tables of the database that are used in storing personal data of data subjects.

Here, for example, the scan module 136 may analyze the names of the various fields in identifying those fields that are used for storing personal data. For example, the scan module 136 may determine that a field named “FIRST_NAME” is used for storing a data subject's first name, a field named “SSN” is used for storing a data subject's social security number, a field named “E_MAIL” is used for storing a data subject's email address, and so forth. The scan module 136 may use also, or instead, other information found in the schema in identifying the fields that are used for storing personal data such as, for example, a description provided in the schema for each field.

Once the scan module 136 has identified the data elements associated with the data source 137 that are involved in handling the target data, the scan module 136 queries one or more data samples for each of the identified data elements from the data source in Operation 420. As previously noted, the data samples provide real occurrences of the type of target data for which the data element is being used to handle the target data. For example, if a data element is being used to store data subject's first names, then the data samples queried for the data element may include “John,” “Steven,” “Rob,” “Frank,” “Chris,” and/or the like.

The scan module 136 may retrieve any number of data samples for a data element depending on the circumstances. For example, the request received for conducting the scan of the data source 137 may indicate the number of data samples that are to be collected for each data element. In addition, the scan module 136 may query the data samples for a data element using various criteria. For example, the scan module 136 may query the data samples for a data element by randomly selecting the data samples from the data samples available for the data element, or the scan module 136 may query the data samples for the data element using some type of formulistic approach such as selecting every sixth data sample that is available for the data element.

Once the scan module 136 has queried the data samples for each of the data elements, the scan module 136 generates a source dataset in Operation 425. According to various aspects, the source dataset includes each of the data elements (e.g., an identifier thereof) identified as involved in handling target data for the data source 137, as well as the data samples collected for each of the data elements.

### Classification Module

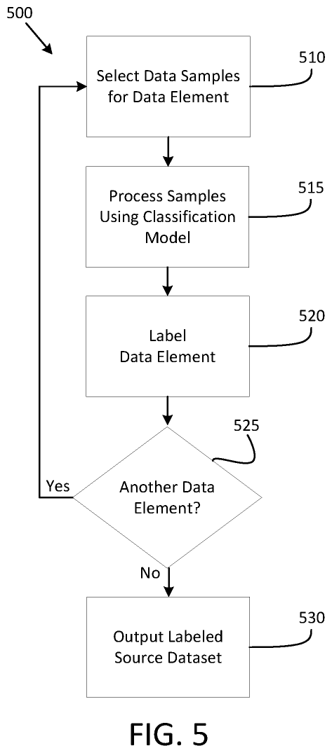

Turning now to FIG. 5, additional details are provided regarding a classification module 135 used for labeling each of the data elements identified in a source dataset generated for a data source 137 in accordance with various aspects of the disclosure. Similar to the scan module 136, the classification module 135 according to various aspects can be installed within the source computing system 130 in which the data source 137 is located. Therefore, the flow diagram shown in FIG. 5 may correspond to operations carried out, for example, by computing hardware found in the source computing system 130 as described herein, as the computing hardware executes the classification module 135.

According to various aspects, the classification module 135 is primarily tasked with generating a label for each of the data elements identified for a data source 137 that is involved in handling target data to identify a type of target data associated with the data element. For example, the scan module 136 (or some other module) may invoke the classification module 135 to generate the labels for the data elements identified within a source dataset generated for the data source 137.

Therefore, the process 500 involves the classification module 135 selecting one or more of the data samples provided in the source dataset for a data element in Operation 510. The classification module 135 then processes the data sample(s) using a machine-learning classification model in Operation 515.

According to various aspects, the machine-learning classification model may be an ensemble that comprises a plurality of classifiers in which each classifier is used in generating a prediction for a different type of target data that may be associated with a data element. For example, the machine-learning classification model may include a first classifier for generating a prediction as to whether a particular data element is involved in handling first name data, a second classifier for generating a prediction as to whether a particular data element is involved in handling last name data, a third classifier for generating a prediction as to whether a particular data element is involved in handling telephone number data, a fourth classifier for generating a prediction as to whether a particular data element is involved in handling social security data, and so forth.

According to particular aspects, the machine-learning classification model may be configured as a multi-label classification model in which the classifiers are provided in a onevsrest, binary relevance, classifier chain, and/or the like configuration. In addition, depending on the configuration, the classifiers may use any number of different algorithms for generating the predictions such as, for example, a K-nearest neighbor algorithm modified for multi-label classification (MLKnn). Therefore, according to particular aspects, the machine-learning classification model may generate a feature representation (e.g., a feature vector) having components associated with the different types of target data. Each of the components may provide a prediction (e.g., prediction value) with respect to the corresponding type of target data applying to the particular data element.

At Operation 520, the classification module 135 labels the data element based on the predictions generated by the machine-learning classification model. According to various aspects, the classification module 135 performs this particular operation by determining whether the prediction generated for a particular type of target data satisfies a threshold. Since the machine-learning classification model is configured as a multi-label classification model according to various aspects, the classification module 135 may assign more than one label to the data element. For example, a data element may be used in storing both a data subject's home address and telephone number. Therefore, in this example, the classification module 135 may assign a first label identifying the type of target data associated with the data element is home address and a second label identifying the type of target also associated with the data element is telephone number.

At Operation 525, the classification module 135 determines whether another data element is identified in the source dataset. If so, then the classification module 135 returns to Operation 410, selects one or more data samples for the next data element, and processes the one or more data samples as described above to label the next data element. Once the classification module 135 has processed all of the data elements identified in the source dataset (e.g., processed the data samples thereof) and labeled them accordingly, the classification module 135 outputs a labeled source dataset in Operation 530.

At this point, the classification module 135 (or some other module) may provide the labeled source dataset to an anonymizer module 125. Depending on the circumstances, the anonymizer module 125 may also reside within the source computing system 130, a proxy computing system 120, or a review computing system 110. However, ss previously noted, the anonymizer module 125 may be installed within the source computing system 130 or the proxy computing system 120, separate from the review computing system 110, so that data samples for various data elements provided in the labeled source dataset may be anonymized before making the source dataset available as a review dataset within the review computing system 110.

### Anonymizer Module

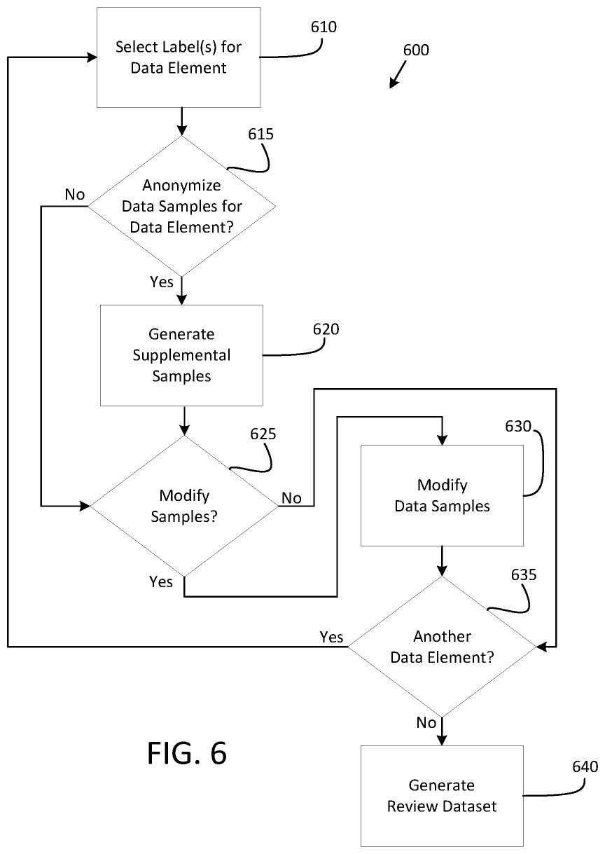

Turning now to FIG. 6, additional details are provided regarding an anonymizer module 125 used for anonymizing data samples provided for various data elements in a labeled source dataset in accordance with various aspects of the disclosure. As previously noted, the anonymizer module 125 according to various aspects can be installed within a source computing system 130, a proxy computing system 120, or a review computing system 110. Therefore, the flow diagram shown in FIG. 6 may correspond to operations carried out, for example, by computing hardware found in the source computing system 130, the proxy computing system 120, or the review computing system 110, as described herein, as the computing hardware executes the anonymizer module 125.

In general, the anonymizer module 125 is tasked to identify those data elements provided in the labeled source dataset that need to have their corresponding data samples anonymized and anonymizing the data samples accordingly. Therefore, the process 600 involves the anonymizer module 125 selecting the one or more labels assigned to a data element found in the labeled source dataset in Operation 610. Once selected, the anonymizer module 125 determines whether the data samples provided for the data element in the labeled source dataset need to be anonymized in Operation 615.

According to various aspects, the anonymizer module 125 may determine whether the data samples for the data element need to be anonymized based on the label(s) assigned to the data element. For example, the anonymizer module 125 may compare each of the labels to a table of labels/types of target data and respective anonymization indicators to determine whether a label assigned to the data element is associated with a type of target data that is to be anonymized. If the anonymizer module 125 determines that the data samples for the data element do not need to be anonymized, then the anonymizer module 125 stores the data element (e.g., identifier thereof) and the corresponding data samples for the data element in a review dataset. Although according to particular aspects, as discussed further herein, the anonymizer module 125 may first determine whether the real occurrences of the types of target data represented in data samples need to be modified to obfuscate the real occurrences.

If, instead, the anonymizer module 125 determines that the data samples for the data element need to be anonymized, then the anonymizer module 125 generates one or more supplemental anonymizing data samples for the data element in Operation 620. According to particular aspects, the anonymizer module 125 may perform this operation by querying the supplemental anonymizing data sample(s) from a pool of supplemental anonymizing data samples. Here, the pool of supplemental anonymizing data samples may include subsets of data samples for the various types of target data that may be handled by a data source 137. For example, according to particular aspects, the pool of supplemental anonymizing data samples may be comprised of a plurality of tables stored in one or more data repositories 126 in which each table may include (a subset of) supplemental anonymizing data samples for a particular type of target data. Therefore, the anonymizer module 125 may locate the particular table having the corresponding supplemental anonymizing data samples based on the label assigned to the data element and retrieve one or more supplemental anonymizing data samples from the table.

According other aspects, the anonymizer module 125 may employ a process for generating (e.g., on-the-fly) supplemental anonymizing data samples for a given type of target data. For example, the anonymizer module 125 may use a random generator in generating the supplemental anonymizing data samples. Here, the anonymizer module 125 may provide the random generator with a format for the data samples, as well as what types of characters should be provided in the samples (e.g., numbers, letters, special characters, any combination thereof). In turn, the random generator may generate the supplemental anonymizing data samples accordingly.

As a specific example, the anonymizer module 125 may reference a table, and based on the label assigned to the data element, identify a format for the supplemental anonymizing data samples from the table. For instance, the label may indicate that the data element is used for handling telephone numbers for data subjects. Therefore, the table may indicate that the format for the supplemental anonymizing data samples is numbers in the form of “XXX-XXX-XXXX.” In another instance, the label may indicate that the data element is used for handling account numbers for data subjects. Therefore, the table may indicate that the format for the supplemental anonymizing data samples is a combination of alpha numeric characters in the form of “XXXX-XXXXXXX.” Accordingly, the anonymizer module 125 may retrieve the format from the table and provide the format to the random generator so that the random generator can generate the supplemental anonymizing data samples for the data element. In some instances, the anonymizer module 125 may also, or instead, provide the random generator with an actual data sample for the data element that the random generator may analyze in generating the supplemental anonymizing data samples.

As previously noted, the one or more supplemental anonymizing data samples represent factitious occurrences of the corresponding type of target data (e.g., not associated with a real data subject). For example, the supplemental anonymizing data samples for a particular data element involved in handling a data subject's phone number may include samples having different, randomly-generated and/or randomly-identified, phone numbers. In addition, according to some aspects, the anonymizer module 125 may ensure that the supplemental anonymizing data samples can pass a checksum validation where the original data samples provided for the data element in the labeled source dataset would be required to pass a checksum validation. Further, the anonymizer module 125 may also, or instead, ensure that the supplemental anonymizing data samples have the appropriate format, such as ensuring, for example, that the content of the samples is text or numeric where the original data samples have text or numeric.

As a specific example, the source computing system 130 may identify a data element for a data source 137 that is involved in handling first names of data subjects. Here, a data sample may have been retrieved for the data element representing a real occurrence of the type of target data associated with the data element with the content “John.” Accordingly, the source computing system 130 may have assigned a data element with the label “First Name.” The anonymizer module 125 may evaluate the data sample and/or respective label assigned to the data element and determine that a “First Name” type of target data is to be anonymized. The anonymizer module 125 may then generate one or more supplemental anonymizing data samples (e.g., that are unrelated to any real data subjects) of the data type “First Name.” Such supplemental anonymizing data samples might include, for example, samples with the first names “Robert,” “Steven,” and “Javier.” The anonymizer module 125 may then insert (intermingle) these supplemental anonymizing data samples into the labeled source dataset proximate to the data sample for “John.” In this way, the real occurrence of “John” is obfuscated by the supplemental anonymizing data samples. Accordingly, this may prevent identification of the real data subject “John” by preventing easy association of John's first name with real occurrences of other types of target data found in labeled source dataset that may be associated with the data subject.

For example, the scan module 136 (as previously discussed) may have used a single record from a database that has more than one data element handling the target data in generating data samples for all the data elements found in the record. For example, the record may store first name (“John”), last name (“Smith”), social security number (“999-99-9999”), and email address (jsmith@gmail.com) and the scan module 126 may have used this record in generating a sample for each of these data elements. Therefore, someone who is reviewing the labels of the data elements and looking at the samples (“John” for first name, “Smith” for second name, etc.) may be able to piece together the samples for the separate elements and figure out that John Smith's social security number is 999-99-9999. This can be even more problematic if a limited number of samples are returned. Therefore, including the supplemental anonymizing data samples into the labeled source dataset can help address this problem.

As another specific example, the source computing system 130 may have identified a data element for a data source 137 that is involved in handling telephone numbers of data subjects. Here, a data sample may have been retrieved for the data element representing a real occurrence of the type of target data associated the data element with the content “678-809-4032” that is subsequently assigned the label “Phone Number.” The anonymizer module 125 may evaluate this data sample and the respective label assigned to the data element and determine that a “Phone Number” type of target data is to be anonymized. The anonymizer module 125 may then generate one or more supplemental anonymizing data samples that are unrelated to any real data subjects having real occurrences of the data type “Phone Number” handled by the data source 137. For example, the anonymizer module 125 may randomly generate supplemental anonymizing data samples having phone numbers “904-336-1402,” “352-916-3285,” and “678-225-1375” and insert these supplemental anonymizing data samples into the labeled source dataset proximate to the data sample representing the real occurrence of the type of target data with the content “678-809-4032.” In this way, the real occurrence for the phone number “678-809-4032” is obfuscated by the supplemental anonymizing data samples. Again, this may prevent identification of the real data subject associated with “678-809-4032” by preventing easy association of the data subject's phone number with other types of target data provided in the labeled source dataset that may be associated with the data subject.

At Operation 625, the anonymizer module 125 determines whether the data samples for the data element need to be modified. Similar to determining whether supplemental anonymizing data samples need to be generated for the data samples, the anonymizer module 125 may determine whether to modify the data samples based on the label(s) assigned to the data element (e.g., based on the type of target data associated with the data element). Therefore, if the anonymizer module 125 determines the data samples for the data element should be modified, then the anonymizer module 125 does so in Operation 630.

For instance, according to particular aspects, the anonymizer module 125 may mask certain characters found in the content of the data samples to obfuscate the data samples. For example, if the data element is used in handling social security numbers or credit card numbers for data subject, then the anonymizer module 125 may mask one or more digits of a social security number or a credit card number provided in a data sample. In other instances, the anonymizer module 125 may replace one or more characters with meaningless placeholder information (e.g., with one or more special characters). Such an operation can allow for further anonymization of occurrences of the types of target data while retaining the benefits of using supplemental anonymizing data samples as described herein. Such masking or replacement data may be data that retains one or more characteristics expected of the particular type of target data (e.g., one or more numbers may be replaced by a particular number such as 0), which may allow the data samples to still pass checksum validation and/or to conform to an expected format, such as a particular number of digits, etc.

At Operation 635, the anonymizer module 125 determines whether another data element, and corresponding data samples, is found in the labeled source dataset. If so, then the anonymizer module 125 returns to Operation 510, selects the label(s) for the next data element, and performs the operations just described for the next data element. Once the anonymizer module 125 has processed all of the data elements provided in the labeled source dataset, the anonymizer module 125 generates a review dataset in Operation 640 that includes the data elements and corresponding data samples for the data elements with the supplemental anonymizing data samples intermingled within the data samples where appropriate. For example, the anonymizer module 125 may insert the supplemental anonymizing data samples into the appropriate data samples found in the labeled source dataset and sort the data samples randomly, alphabetically, in numerical order, etc. to generate the set of data samples found in the review dataset for the corresponding data element. Therefore, the review dataset may include sets of data samples for certain data elements that have been anonymized and sets of data samples for other data elements that have not been anonymized.

In another example, the anonymizer module 125 may generate the review dataset by intermingling the supplemental anonymizing data samples, where appropriate, with the data samples found in the labeled source dataset by transmitting data samples to a review computing system 110 for analysis and/or review in a randomized order that obfuscates which samples are the actual samples from the labeled source dataset. As a specific example, the labeled source dataset may include five data samples (R1, R2, . . . R5) and the anonymizer module 125 may have generated five supplemental anonymizing data samples (A1, A2, . . . A5). Here, the anonymizer module 125 may transmit the data samples from the labeled source dataset and the supplemental anonymizing data samples randomly at times t1, t2, . . . t10 as shown in Table 1.

TABLE 1
Transmission example

| Sample | Time |
|---|---|
| A1 | t1 |
| A2 | t2 |
| R1 | t3 |
| A3 | t4 |
| R2 | t5 |
| R3 | t6 |
| A4 | t7 |
| R4 | t8 |
| R5 | t9 |
| A4 | t10 |

Accordingly, the random selection of a given sample from the labeled source dataset or supplemental anonymizing data sample at time ‘t’ would not indicate which samples are actual data samples or supplemental anonymizing samples.

### Review Module

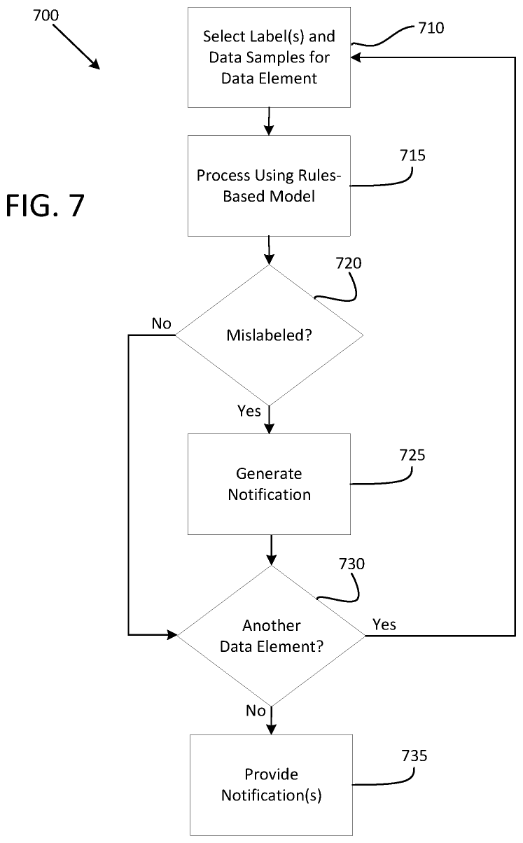

Turning now to FIG. 7, additional details are provided regarding a review module 115 used for analyzing a review dataset to determine whether any of the data elements provided in the review dataset have been mislabeled in accordance with various aspects of the disclosure. As previously noted, the review module 115 according to various aspects can be provided through a review computing system 110. Therefore, the flow diagram shown in FIG. 7 may correspond to operations carried out, for example, by computing hardware found in the review computing system 110, as described herein, as the computing hardware executes the review module 115.

According to various aspects, the review module 115 can be used in analyzing a review dataset to identify data element provided in the dataset that are (potentially) mislabeled. For example, such analysis can assist personnel in reviewing the review dataset for accuracy by filtering out data elements that may be mislabeled so that the personnel does not necessarily need to review the data samples for all the data elements in determining whether they have been accurately labeled and/or mapped.

Therefore, the process 700 involves the review module 115 selecting the label(s) and one or more of the corresponding data samples for a data element in Operation 710. The review module 115 then processes the label(s) and the corresponding data sample(s) using a rules-based model in Operation 715. According to various aspects, the rules-based model may use a set of rules in evaluating whether the label(s) assigned to the data element are correct in light of the corresponding data sample(s). For example, one of the rules provided in the set of rules may indicate that for data elements that has been labeled as a “Phone Number” type, the corresponding data samples should have a format of “XXX-XXX-XXXX.” Similarly, one of the rules provided in the set of rules may indicate that for data elements that has been labeled as a “Social Security Number” type, the corresponding data samples should have a format of “XXX-XX-XXXX.” Accordingly, the rules found in the set of rules may be applicable to other characteristics of the data samples. For example, one or more of the rules may define that the data samples provided for a particular label (e.g., for a particular type of target data) should be composed or numbers, letters, alphanumeric characters, etc.

At Operation 720, the review module 115 determines whether the data element has been mislabeled. If so, then the review module 115 generates a notification for the mislabeled data element in Operation 725. At this point, the review module 115 determines whether the review dataset includes another data element in Operation 730. If so, then the review module 115 returns to Operation 610, selects the label(s) and one or more corresponding data samples for the next data element, and process the label(s) and one or more corresponding data samples using the rules-based model as just described. Once the review module 115 has processed the labels and corresponding data samples for all of the data elements provided in the review dataset, the review module 115 provided the notification(s) in operation 735. For example, the review module 115 may provide the notifications through one or more graphical user interfaces to personnel of the entity associated with the review dataset. In another example, the review module 115 may provide the notifications through one or more electronic communications, such as emails, to appropriate personnel.

### Example Technical Platforms

Aspects of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example aspects, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

According to various aspects, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

According to various aspects, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various aspects are described to use a computer-readable storage medium, other types of computer-readable storage media may be substituted for or used in addition to the computer-readable storage media described above.

Various aspects of the present disclosure may also be implemented as methods, apparatuses, systems, computing devices, computing entities, and/or the like. As such, various aspects of the present disclosure may take the form of a data structure, apparatus, system, computing device, computing entity, and/or the like executing instructions stored on a computer-readable storage medium to perform certain steps or operations. Thus, various aspects of the present disclosure also may take the form of entirely hardware, entirely computer program product, and/or a combination of computer program product and hardware performing certain steps or operations.

Various aspects of the present disclosure are described below with reference to block diagrams and flowchart illustrations. Thus, each block of the block diagrams and flowchart illustrations may be implemented in the form of a computer program product, an entirely hardware aspect, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some examples of aspects, retrieval, loading, and/or execution may be performed in parallel such that multiple instructions are retrieved, loaded, and/or executed together. Thus, such aspects can produce specially configured machines performing the steps or operations specified in the block diagrams and flowchart illustrations. Accordingly, the block diagrams and flowchart illustrations support various combinations of aspects for performing the specified instructions, operations, or steps.

### Example System Architecture

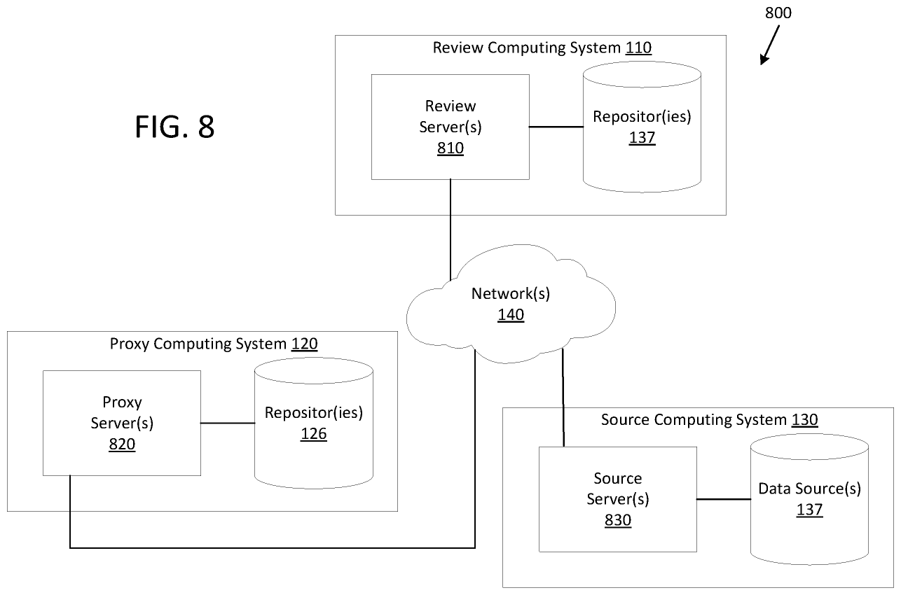

FIG. 8 is a block diagram of a system architecture 800 that can be used in mapping target data for various data sources 137 found in a source computing system 130 according to various aspects of the disclosure as detailed herein. Components of the system architecture 800 are configured according to various aspects to assist an entity in mapping target data for one or more data sources 137 found in a source computing system 130 and used by the entity in handling target data.

As may be understood from FIG. 8, the system architecture 800 according to various aspects may include a review computing system 110 that comprises one or more review servers 810 and one or more data repositories 116. For example, the one or more data repositories 116 may include a data repository for storing review datasets generated for scans performed on data sources 137 in mapping data elements of the data sources 137 involved in handling target data. In addition, the one or more data repositories 116 may include a repository for storing various set of rules that can be used in analyzing the review datasets as described herein. Although the review server(s) 810 and repository(ies) 116 are shown as separate components, according to other aspects, these components 810, 116 may comprise a single server and/or repository, a plurality of servers and/or repositories, one or more cloud-based servers and/or repositories, or any other suitable configuration.

In addition, the system architecture 800 according to various aspects may include a proxy computing system 120 that comprises one or more proxy servers 820 and one or more data repositories 126. For example, the one or more data repositories 126 may include a data repository for storing source datasets generated for scans performed on data sources 137 in mapping data elements of the data source 137 involved in handling target data. In addition, the one or more data repositories 126 may include a repository for storing various pools of supplemental anonymizing data samples and/or a machine-learning classification model as described herein. Although the proxy server(s) 820 and repository(ies) 126 are shown as separate components, according to other aspects, these components 820, 126 may comprise a single server and/or repository, a plurality of servers and/or repositories, one or more cloud-based servers and/or repositories, or any other suitable configuration.

Further, the system architecture 700 according to various aspects may include a source computing system 130 that comprises one or more source servers 830 and one or more data sources 137. For example, the one or more data sources 137 may include components such as servers, data repositories, databases, and/or the like used in handling target data as described herein. Although the source server(s) 830 and data source(s) 137 are shown as separate components, according to other aspects, these components 830, 137 may comprise a single server and/or repository, a plurality of servers and/or repositories, one or more cloud-based servers and/or repositories, or any other suitable configuration.

The review server(s) 810, proxy server(s) 820, and/or source server(s) 830 may communicate with, access, and/or the like with each other over one or more networks 140. According, the review server(s) 810 may execute a review module 115 as described herein. The proxy server(s) 820 may execute an anonymizer module 125 as described herein. The sources server(s) 830 may execute a classification module 135 and a scan module 136 as described herein. Further, according to particular aspects, the review server(s) 810 may provide one or more graphical user interfaces through which personnel of an entity can interact with the review computing system 110. Furthermore, the review server(s) 810, proxy server(s) 820, and/or source server(s) 830 may provide one or more interfaces that allow the review computing system 110, proxy computing system 120, and/or source computing system 130 to communicate with each other such as one or more suitable application programming interfaces (APIs), direct connections, and/or the like.

### Example Computing Hardware

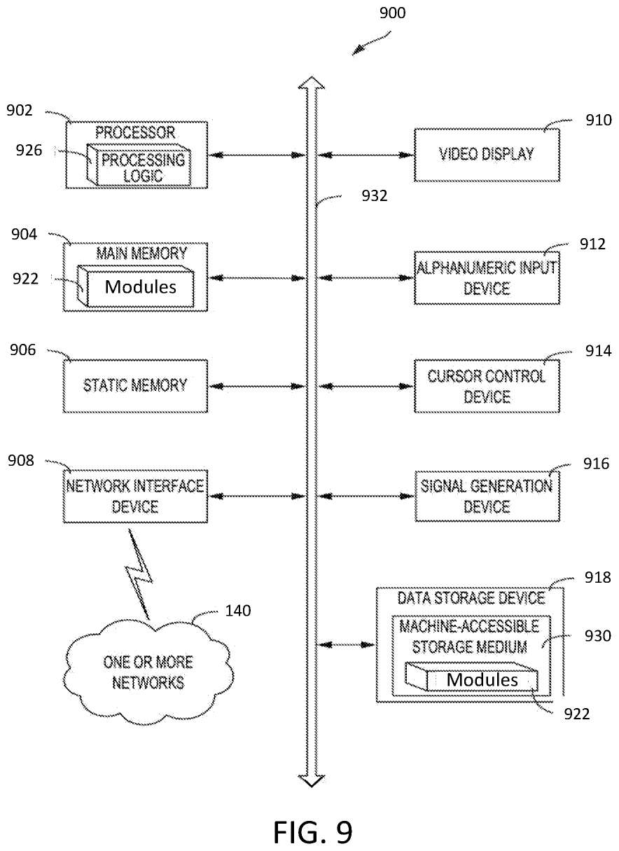

FIG. 9 illustrates a diagrammatic representation of a computing hardware device 800 that may be used in accordance with various aspects of the disclosure. For example, the hardware device 900 may be computing hardware such as a review server 810, proxy server 820, or source server 830 as described in FIG. 8. According to particular aspects, the hardware device 900 may be connected (e.g., networked) to one or more other computing entities, storage devices, and/or the like via one or more networks such as, for example, a LAN, an intranet, an extranet, and/or the Internet. As noted above, the hardware device 900 may operate in the capacity of a server and/or a client device in a client-server network environment, or as a peer computing device in a peer-to-peer (or distributed) network environment. According to various aspects, the hardware device 800 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 800 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 900 includes a processor 902, a main memory 904 (e.g., read-only memory (ROM), flash memory, dynamic random-access memory (DRAM) such as synchronous DRAM (SDRAM), Rambus DRAM (RDRAM), and/or the like), a static memory 906 (e.g., flash memory, static random-access memory (SRAM), and/or the like), and a data storage device 818, that communicate with each other via a bus 932.

The processor 902 may represent one or more general-purpose processing devices such as a microprocessor, a central processing unit, and/or the like. According to some aspects, the processor 902 may be a complex instruction set computing (CISC) microprocessor, reduced instruction set computing (RISC) microprocessor, very long instruction word (VLIW) microprocessor, a processor implementing other instruction sets, processors implementing a combination of instruction sets, and/or the like. According to some aspects, the processor 902 may be one or more special-purpose processing devices such as an application specific integrated circuit (ASIC), a field programmable gate array (FPGA), a digital signal processor (DSP), network processor, and/or the like. The processor 902 can execute processing logic 926 for performing various operations and/or steps described herein.

The hardware device 900 may further include a network interface device 908, as well as a video display unit 910 (e.g., a liquid crystal display (LCD), a cathode ray tube (CRT), and/or the like), an alphanumeric input device 912 (e.g., a keyboard), a cursor control device 914 (e.g., a mouse, a trackpad), and/or a signal generation device 916 (e.g., a speaker). The hardware device 900 may further include a data storage device 918. The data storage device 918 may include a non-transitory computer-readable storage medium 930 (also known as a non-transitory computer-readable storage medium or a non-transitory computer-readable medium) on which is stored one or more modules 922 (e.g., sets of software instructions) embodying any one or more of the methodologies or functions described herein. For instance, according to particular aspects, the modules 922 include a review module 115, anonymizer module 125, classification module 135, and/or scan module 136 as described herein. The one or more modules 922 may also reside, completely or at least partially, within main memory 904 and/or within the processor 902 during execution thereof by the hardware device 900—main memory 904 and processor 902 also constituting computer-accessible storage media. The one or more modules 922 may further be transmitted or received over a network 140 via the network interface device 908.

While the computer-readable storage medium 930 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 900 and that causes the hardware device 900 to perform any one or more of the methodologies of the present disclosure. The term “computer-readable storage medium” should accordingly be understood to include, but not be limited to, solid-state memories, optical and magnetic media, and/or the like.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### CONCLUSION

While this specification contains many specific aspect details, these should not be construed as limitations on the scope of any invention or of what may be claimed, but rather as descriptions of features that may be specific to particular aspects of particular inventions. Certain features that are described in this specification in the context of separate aspects also may be implemented in combination in a single aspect. Conversely, various features that are described in the context of a single aspect also may be implemented in multiple aspects separately or in any suitable sub-combination. Moreover, although features may be described above as acting in certain combinations and even initially claimed as such, one or more features from a claimed combination may in some cases be excised from the combination, and the claimed combination may be a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in the various aspects described above should not be understood as requiring such separation in all aspects, and the described program components (e.g., modules) and systems may be integrated together in a single software product or packaged into multiple software products.

Many modifications and other aspects of the disclosure will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for the purposes of limitation.

1-20. (canceled)

21. A method comprising:
generating, by one or more hardware processors utilizing a machine-learning classification model, a label identifying a type of target data associated with a data element used by a data source in handling the target data;
determining, by the one or more hardware processors, a plurality of data samples comprising real occurrences of the type of the target data associated with the data element from the data source;
determining, by the one or more hardware processors and based on the label identifying the type of the target data associated with the data element, that the plurality of data samples is to be anonymized;
generating, by the one or more hardware processors and based on determining that the plurality of data samples is to be anonymized, a plurality of supplemental anonymizing data samples associated with the label and comprising a fictitious occurrence of the type of the target data handled by the data source involving the data element as indicated by the label;
generating, by the one or more hardware processors, a review dataset comprising the plurality of supplemental anonymizing data samples intermingled with the plurality of data samples; and
sending, by the one or more hardware processors, the review dataset over a network to a review computing system.

22. The method of claim 21, wherein generating the plurality of supplemental anonymizing data samples comprises:
identifying a subset of supplemental anonymizing data samples from a pool of supplemental anonymizing data samples for a plurality of types of the target data, wherein each supplemental anonymizing data sample of the subset of supplemental anonymizing data samples is associated with the type of the target data; and
selecting the plurality of supplemental anonymizing data samples from the subset of supplemental anonymizing data samples.

23. The method of claim 21, wherein generating the plurality of supplemental anonymizing data samples comprises generating each of the plurality of supplemental anonymizing data samples via a random generator.

24. The method of claim 21 wherein:
generating the label assigned to the data element comprises processing, at a first server, at least one of the plurality of data samples using the machine-learning classification model to generate the label; and
generating the plurality of supplemental anonymizing data samples comprises generating, at a second server, the plurality of supplemental anonymizing data samples.

25. The method of claim 21 further comprising scanning metadata for the data source to identify the data element as being used to handle the target data.

26. The method of claim 21 further comprising modifying each of the plurality of data samples and the plurality of supplemental anonymizing data samples to mask the plurality of data samples and the plurality of supplemental anonymizing data samples.

27. The method of claim 21, wherein the label comprises data identifying the type of the target data as at least one of a first name, a last name, a telephone number, a social security number, a credit card number, an account number, or an email address.

28. A non-transitory computer-readable medium having program code that is stored thereon, the program code executable by one or more processing devices for performing operations comprising:
generating, utilizing a machine-learning classification model, labels identifying types of target data associated with data elements used by a data source in handling the target data, the labels comprising a first label of a first type of the target data and a second label of a second type of the target data;
determining, according to the labels, a first plurality of data samples comprising real occurrences of the first type of the target data associated with a first data element from the data source and a second plurality of data samples comprising real occurrences of the second type of the target data associated with a second data element from the data source;
determining, based on the first label assigned to the first data element by the machine-learning classification model, that the first plurality of data samples does not need to be anonymized, wherein the first label identifies a first type of the target data associated with the first data element;
determining, based on the second label assigned to the second data element by the machine-learning classification model, that the second plurality of data samples is to be anonymized, wherein the second label identifies a second type of the target data associated with the second data element;
generating, based on determining that the second plurality of data samples is to be anonymized, a plurality of supplemental anonymizing data samples associated with the second label and comprising a fictitious occurrence of the second type of the target data handled by the data source involving the second data element as indicated by the second label; and
generating a review dataset comprising the first plurality of data samples, the second plurality of data samples, and the plurality of supplemental anonymizing data samples, wherein the plurality of supplemental anonymizing data samples is intermingled with the second plurality of data samples within the review dataset.

29. The non-transitory computer-readable medium of claim 28, wherein the operations further comprise:
sending the review dataset over a network to a review computing system;
receiving one or more corrected labels for one or more data elements in the review dataset; and
performing one or more additional computing operations utilizing the review dataset with the one or more corrected labels.

30. The non-transitory computer-readable medium of claim 28, wherein generating the plurality of supplemental anonymizing data samples comprises:
identifying a subset of supplemental anonymizing data samples from a pool of supplemental anonymizing data samples for a plurality of types of the target data, wherein each supplemental anonymizing data sample of the subset of supplemental anonymizing data samples is associated with the second type of the target data; and
selecting the plurality of supplemental anonymizing data samples from the subset of supplemental anonymizing data samples.

31. The non-transitory computer-readable medium of claim 28, wherein generating the plurality of supplemental anonymizing data samples comprises generating each of the plurality of supplemental anonymizing data samples via a random generator according to a format based on the second plurality of data samples.

32. The non-transitory computer-readable medium of claim 28, wherein the first label and the second label comprise data identifying the first type of the target data and the second type of the target data as at least one of a first name, a last name, a telephone number, a social security number, a credit card number, an account number, or an email address.

33. A system comprising:
first computing hardware configured to perform operations comprising:
identifying a data element used by a data source in handling target data;
generating, utilizing a machine-learning classification model, a label identifying a type of target data being handled by the data element by processing a plurality of data samples comprising real occurrences of data for the data element; and
second computing hardware communicatively coupled to the first computing hardware, wherein the second computing hardware is configured to perform operations comprising:
receiving the label and the plurality of data samples from the first computing hardware;
determining, based on the label generated by the machine-learning classification model, that the plurality of data samples is to be anonymized;
generating, based on determining that the plurality of data samples is to be anonymized, a plurality of supplemental anonymizing data samples, wherein each of the plurality of supplemental anonymizing data samples is associated with the label and comprises a fictitious occurrence of data for the data element; and
generating a review dataset comprising the plurality of supplemental anonymizing data samples intermingled with the plurality of data samples.

34. The system of claim 33 further comprising:
third computing hardware configured to perform operations comprising:
receiving the review dataset from the second computing hardware;
processing the review dataset using a rules-based model to determine the data element is not handling the type of target data indicated by the label; and
responsive to determining the data element is not handling the type of target data indicated by the label, generate a notification that the label is incorrect.

35. The system of claim 33 further comprising:
third computing hardware configured to perform operations comprising:
providing the review dataset for viewing on a graphical user interface;
receiving an indication via the graphical user interface that the label for the data element is correct; and
responsive to receiving the indication, storing data indicating the data element is used by the data source for handling the type of target data.

36. The system of claim 33, wherein the machine-learning classification model comprises a multi-label classification model, wherein the first computing hardware is configured to utilize the multi-label classification model to assign a plurality of labels to the data element based on a plurality of separate portions of the data element.

37. The system of claim 33, wherein the first computing hardware is configured for identifying the data element used by the data source in handling the target data by scanning metadata for the data source to identify the data element as being used to handle the target data.

38. The system of claim 33, wherein the second computing hardware generates the plurality of supplemental anonymizing data samples by performing operations comprising:
identifying a subset of supplemental anonymizing data samples from a pool of supplemental anonymizing data samples for a plurality of types of the target data, each supplemental anonymizing data sample of the subset of supplemental anonymizing data samples is associated with the type of target data; and
selecting the plurality of supplemental anonymizing data samples from the subset of supplemental anonymizing data samples.

39. The system of claim 33, wherein the second computing hardware generates the plurality of supplemental anonymizing data samples by performing operations comprising generating each of the plurality of supplemental anonymizing data samples via a random generator according to a format based on the plurality of data samples.

40. The system of claim 33, wherein the second computing hardware is configured to perform operations comprising modifying each of the plurality of data samples and the plurality of supplemental anonymizing data samples to mask the plurality of data samples and the plurality of supplemental anonymizing data samples.
